(19) United States
(12) Patent Application Publication
(10) Pub. No.: US 2003/0136797 A1
(43) Pub. Date: Jul. 24, 2003

(54) Portable beverage container having a dispensing mechanism and method therefor

(76) Inventor: Robert Thomason, Parker, AZ (US)

Correspondence Address: WEISS & MOY PC, 4204 NORTH BROWN AVENUE, SCOTTSDALE, AZ, 85251, US

(21) Appl. No.: 10/057,072

(22) Filed: Jan. 23, 2002

(51) Int. Cl. G01F 11/00

(52) U.S. Cl. 222/1; 222/333

(57) ABSTRACT

A portable beverage dispenser has a container for storing the beverage. A pumping mechanism is located in an side section of the container. The pumping mechanism is used for dispensing the beverage when the pumping mechanism is activated.

### BACKGROUND OF THE INVENTION

1. Field of the Invention

This invention relates to a beverage container, and more specifically, to a portable beverage container which has a dispensing mechanism to allow an individual to easily dispense the beverage stored in the container.

2. Description of the Prior Art

Many individuals like to work or play outdoors. It has been recommend for people who work or play outdoors, that they drink continuous amounts of water or other beverages in order to replenish body fluids which may be lost while being outdoors. Unfortunately, when the weather is fairly warm, it makes it difficult for these individuals to remain outdoors for long periods of time.

In order to solve this problem, portable beverage dispensers have been invented. These beverage dispensers allow people to store beverages nearby. This will allow people who work and play outdoors to continuously drink water or other beverages to replenish any body fluids which may be lost due to the warm weather.

Most people who work and play outdoors use a standard portable water cooler. These water coolers have an insulated storage compartment for holding different amounts of a beverage. On an outside bottom section of the water cooler is a spout for dispensing the beverage. The spout generally has a button which must be depressed in order to dispense the beverage.

The problem with current water coolers is that it is difficult to dispense the beverage. In order to dispense the beverage, one must put a cup or his/her mouth below the dispensing spout. This requires one to elevate the water cooler. Unfortunately for larger water coolers, when the water cooler is full with a beverage, it is extremely heavy and difficult to lift.

Another problem with present water coolers occur when the level of the beverage stored in the water cooler begins to get to a fairly low level. When this occurs, it is difficult to dispense the remaining beverage from the water cooler. Generally, one has to lift up the water cooler and tilt the water cooler in the direction of the spout. This will force the remaining beverage in the water cooler to flow towards the spout so that it may be dispensed through the spout. Unfortunately, this is fairly cumbersome to do a single individual.

Therefore a need existed to provide an improved portable beverage dispenser. The improved portable beverage dispenser must be able to easily dispense a beverage. The improved portable beverage dispenser must be able to easily dispense a beverage without the problems associate with prior art water coolers.

### SUMMARY OF THE INVENTION

In accordance with one embodiment of the present invention, it is an object of the present invention to provide an improved portable beverage dispenser.

It is another object of the present invention to provide an improved portable beverage dispenser that is able to easily dispense a beverage.

It is yet another object of the present invention to provide an improved portable beverage dispenser that is able to easily dispense a beverage without the problems associate with prior art water coolers.

### BRIEF DESCRIPTION OF THE PREFERRED EMBODIMENTS

In accordance with one embodiment of the present invention a portable beverage dispenser is disclosed. The portable beverage dispenser has a container for storing the beverage. A pumping mechanism is located in an side section of the container. The pumping mechanism is used for dispensing the beverage when the pumping mechanism is activated.

In accordance with another embodiment of the present invention a method of providing a portable beverage dispenser is disclosed. The method comprises the steps of: providing an insulated container for storing the beverage; and providing a pumping mechanism located in an side section of the container for dispensing the beverage when the pumping mechanism is activated, the pumping mechanism comprising: a pump; a power supply coupled to the pump; and a dispenser coupled to the pump for dispensing the beverage stored in the container when the pump is activated wherein the dispenser comprises: a tubing having a first coupled to an outlet of the pump; and a dispensing spout coupled to a second end of the tubing.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings, wherein like reference numerals and symbols represent like elements.

FIG. 1 is an elevated perspective view of one embodiment of the portable beverage dispenser with dispensing mechanism of the present invention.

FIG. 2 is a cross-sectional side view of the portable beverage dispenser with dispensing mechanism depicted in FIG. 1.

FIG. 3 is a cross-sectional bottom view of another embodiment of the portable beverage dispenser with dispensing mechanism of the present invention.

FIG. 4 is a cross-section bottom view of another embodiment of the portable beverage dispenser with dispensing mechanism of the present invention.

FIG. 5 is an elevated perspective view of another embodiment of the portable beverage dispenser with dispensing mechanism of the present invention.

FIG. 6 is a cross-sectional side view of the portable beverage dispenser with dispensing mechanism depicted in FIG. 5.

### DETAILED DESCRIPTION OF THE PREFERRED EMBODIMENT

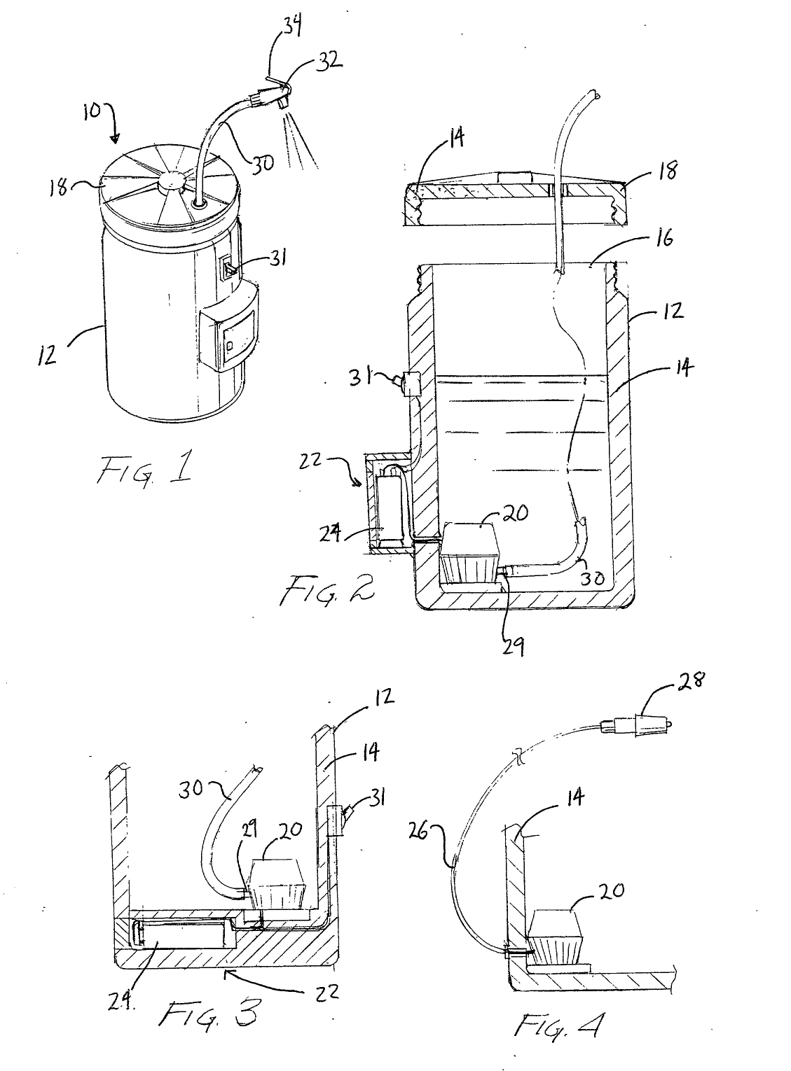

Referring to FIGS. 1-4, a portable beverage dispenser with a dispensing mechanism 10 (hereinafter beverage dispenser 10) is shown. The beverage dispenser 10 is comprised of a container 12. The container 12 is used for storing the beverage to be dispensed. The container 12 may be of various sizes and shapes and may be made of various types of material. In general, the container 12 is made from a light weight but sturdy material like plastic. However, this should not be seen as to limit the scope of the present invention.

The container 12 is generally insulated. The insulation will allow the container 12 to keep the beverage stored in the container 12 at a constant temperature. As may be seen in FIGS. 1-4, the container 12 will have an insulating layer 14. The insulating layer 14 is located between the inner and outer surfaces of the container 12.

The container 12 will generally have an opening 16 (FIG. 2) located at the top of the container 12. The opening 16 is used in order to fill the container with a beverage. The opening 16 will be covered with a lid 18. The lid 18 will form a leakproof cover over the opening 16 when properly installed. Thus, the lid 18 will prevent any of the beverage from leaking out of the top opening 16 when properly installed. The lid 18 may also have an insulating layer 14 in order to keep the stored beverage at a constant temperature.

Located in the bottom interior section of the container 12 is a pumping mechanism 20. The pumping mechanism 20 is used to dispense the beverage stored in the container 12. The pumping mechanism 20 has enough power to dispense the beverage a distance of ten feet or more depending on the horse power of the pumping mechanism. The pumping mechanism 20 is generally a low horsepower sump pump. The pumping mechanism 20 may be an AC or a DC pumping mechanism 20. However, a DC powered pumping mechanism 20 will allow the beverage dispenser 10 to be more portable.

The pumping mechanism 20 will be coupled to a power source 22. In accordance with one embodiment of the present invention, the power source 22 is a battery 24. The battery 24 may be located in different areas on the container 12. For example, in FIGS. 1 and 2, the battery 24 is located on the side of the container 12. In FIG. 3, the battery 24 is located in a bottom section of the container 12. The location of the battery 12 is a design choice and should not be seen as to limit the scope of the present invention.

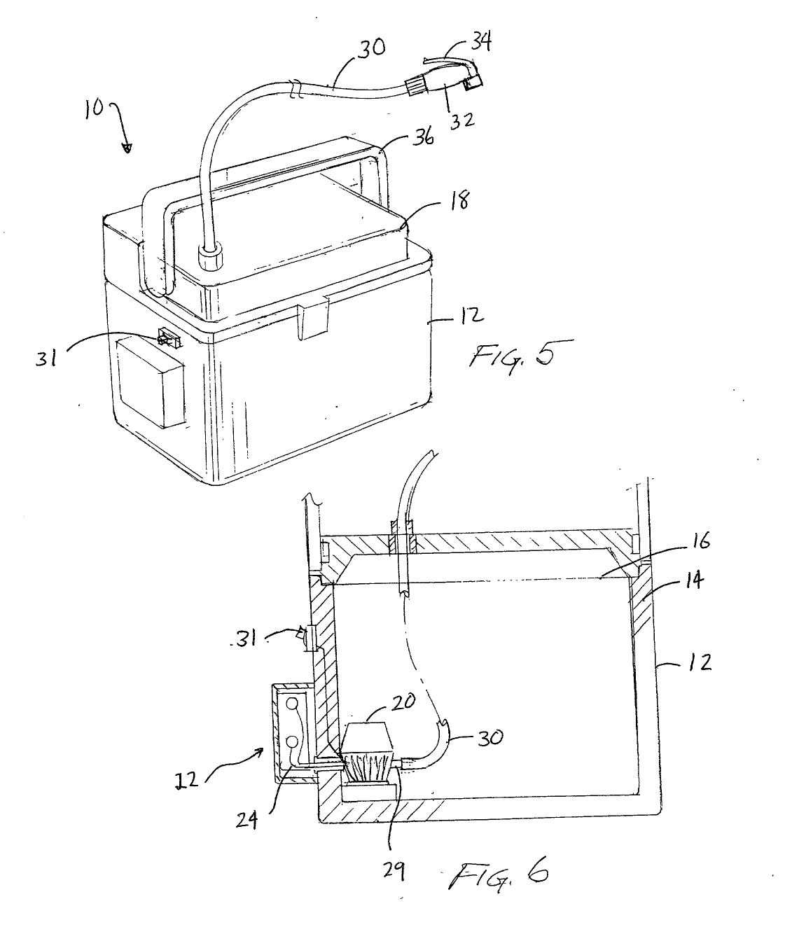

The power source 22 may be devices other than a battery 22. For example, as seen in FIG. 4, the pumping mechanism 20 has wiring 26 extending from the pumping mechanism 20 out through the exterior surface of the container 12. A sealant is used to ensure that the beverage will not leak out of the opening where the wiring 26 exits the container 12. On the end of the wiring 26 opposite from the pumping mechanism 20 is a outlet plug 28. In accordance with one embodiment of the present invention, the outlet plug 28 is configured as a DC outlet plug. The DC outlet plug will allow the pumping mechanism 20 to be connected to the DC outlet in a vehicle. In accordance with another embodiment of the present invention, the outlet plug 28 is configured as an AC outlet plug. The AC outlet plug will allow the pumping mechanism 20 to be coupled to an AC outlet.

The end of the wiring 26 opposite from the pumping mechanism 20 may also be coupled to a small solar panel. The solar panel would then be used to power the pumping mechanism 20. The solar panel could also be coupled to the battery 22. This would allow the solar panel to recharge the battery 22.

A switch 31 is coupled to the power source 22 and to the pumping mechanism 20. The switch 31 is used to turn the pumping mechanism 20 on and off. It should be noted that the switch 31 is not required. The pumping mechanism 20 may be directly coupled to a power source 22 without the switch 31. However, the switch 31 will allow one to control the operation of the pumping mechanism 20. The switch 31 will further allow one to save energy and prolong the life of the pumping mechanism 20.

A tubing 30 is coupled to the pumping mechanism 20. The tubing 30 will have one end coupled to an outlet 29 of the pumping mechanism 20. When the pumping mechanism 20 is activated, the beverage stored in the container 12 will be drawn into an inlet section of the pumping mechanism 20. The pumping mechanism 20 will then force the beverage out of the outlet 29 through the tubing 30. At the end of the tubing opposite of the pumping mechanism 20 is a dispensing device 32. The dispensing device 32 will allow one to dispense the beverage when the pumping mechanism 20 is activated. The dispensing device 32 will generally have a switch 34. The switch 34 will allow one to dispense the beverage. By activating the switch, the beverage will flow out of the dispensing device 32. By releasing the switch, the beverage will no longer low out of the dispensing device 32.

Referring now to FIGS. 5 and 6 wherein like numerals and symbols represent like elements, another embodiment of the beverage dispenser 10 is shown. This embodiment is similar to that previously described in FIGS. 1-4. The main difference is the size and shape of the container 12. The embodiment depicted in FIGS. 5 and 6 is for smaller groups and/or individuals. The container 12 will further have a handle 36. The handle 36 will allow one to more easily transport the beverage dispenser 10.

The beverage dispenser 10 will allow one to quickly and easily dispense a beverage from the container 10. The beverage dispenser 10 can dispense the beverage at a distance of 10 or more feet. Thus, one may be working on a roof of a home and have the container located on the ground. The person may be able to get a drink without having to leave the roof or having to carry a heavy container onto the roof.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A portable beverage dispenser comprising, in combination:
a container for storing the beverage; and
a pumping mechanism located in an side section of the container for dispensing the beverage when the pumping mechanism is activated.

2. A portable beverage dispenser in accordance with claim 1 wherein the pumping mechanism comprises:
a pump;
a power supply coupled to the pump; and
a dispenser coupled to the pump for dispensing the beverage stored in the container when the pump is activated.

3. A portable beverage dispenser in accordance with claim 2 wherein the pumping mechanism further comprises a switch coupled to the power supply and the pumping mechanism.

4. A portable beverage dispenser in accordance with claim 2 wherein the pumping mechanism is a sump pump.

5. A portable beverage dispenser in accordance with claim 2 wherein the power supply is a battery.

6. A portable beverage dispenser in accordance with claim 2 wherein the dispenser comprises:
a tubing having a first coupled to an outlet of the pump; and
a dispensing spout coupled to a second end of the tubing.

7. A portable beverage dispenser in accordance with claim 6 wherein the dispensing spout further comprises a dispensing switch coupled thereto for dispensing the beverage from the dispensing spout.

8. A portable beverage dispenser in accordance with claim 1 wherein the container is an insulated container.

9. A portable beverage dispenser in accordance with claim 1 wherein the container has an opening located on a top section thereof for filling the container with the beverage.

10. A portable beverage dispenser in accordance with claim 9 wherein the container further comprises a top section for covering the opening.

11. A portable beverage dispenser comprising, in combination:
a container for storing the beverage; and
a pumping mechanism located in an side section of the container for dispensing the beverage when the pumping mechanism is activated, the pumping mechanism comprising:
a pump;
a power supply coupled to the pump; and
a dispenser coupled to the pump for dispensing the beverage stored in the container when the pump is activated wherein the dispenser comprises:
a tubing having a first coupled to an outlet of the pump; and
a dispensing spout coupled to a second end of the tubing.

12. A portable beverage dispenser in accordance with claim 11 wherein the pumping mechanism further comprises a switch coupled to the power supply and the pumping mechanism.

13. A portable beverage dispenser in accordance with claim 11 wherein the pumping mechanism is a sump pump.

14. A portable beverage dispenser in accordance with claim 11 wherein the power supply is a battery.

15. A portable beverage dispenser in accordance with claim 11 wherein the dispensing spout further comprises a dispensing switch coupled thereto for dispensing the beverage from the dispensing spout.

16. A portable beverage dispenser in accordance with claim 11 wherein the container is an insulated container.

17. A portable beverage dispenser in accordance with claim 11 wherein the container has an opening located on a top section thereof for filling the container with the beverage.

18. A portable beverage dispenser in accordance with claim 17 wherein the container further comprises a top section for covering the opening.

19. A method of providing a portable beverage dispenser comprising the steps of:
providing an insulated container for storing the beverage; and
providing a pumping mechanism located in an side section of the container for dispensing the beverage when the pumping mechanism is activated, the pumping mechanism comprising:
a pump;
a power supply coupled to the pump; and
a dispenser coupled to the pump for dispensing the beverage stored in the container when the pump is activated wherein the dispenser comprises:
a tubing having a first coupled to an outlet of the pump; and
a dispensing spout coupled to a second end of the tubing.

20. The method of claim 19 wherein the pumping mechanism further comprises a switch coupled to the power supply and the pumping mechanism.

21. The method of claim 19 wherein the pumping mechanism is a sump pump.

22. The method of claim 19 wherein the power supply is a battery.

23. The method of claim 19 wherein the dispensing spout further comprises a dispensing switch coupled thereto for dispensing the beverage from the dispensing spout.

24. The method of claim 11 wherein the container comprises:
an opening located on a top section thereof for filling the container with the beverage; and
a top section for covering the opening.
